(19) United States
(12) Patent Application Publication
(10) Pub. No.: US 2002/0057032 A1
(43) Pub. Date: May 16, 2002

(54) Stator for an electric motor

(75) Inventors: Frank Thiele, Bonndorf (DE); Bernhard Kaiser, Bonndorf (DE)

Correspondence Address: SUGHRUE, MION, ZINN, MACPEAK & SEAS, PLLC, 2100 Pennsylvania Avenue, N.W, Washington, DC, 20037-3213, US

(73) Assignee: ALCATEL

(21) Appl. No.: 09/985,239

(22) Filed: Nov. 2, 2001

(30) Foreign Application Priority Data
Nov. 16, 2000 (DE) 10057123.9

(51) Int. Cl. H02K 1/00

(52) U.S. Cl. 310/216

(57) ABSTRACT

The invention relates to a stator for an electric motor, which stator is distinguished by a high space factor, a small winding overhang and a high level of automation for production purposes, there being provided an inner ring having pole shafts which project radially outwards and form first pole shafts for holding windings and second pole shafts which are disposed between the said first pole shafts, and an outer ring which can be connected, in a form-locking manner, to end-face regions of the pole shafts.

### BACKGROUND OF THE INVENTION

The invention is based on a priority application De 100 57 123.9 which is hereby incorporated by reference.

The invention relates to a stator for an electric motor. A stator in which radially projecting pole shafts of the same kind are provided, is known from DE 198 42 948 A1. The pole shafts are equipped with pre-wound coils. Disadvantages of this stator structure are, above all, the large winding overhang, which is linked with a low space factor, and the low level of automation.

The underlying object of the invention is to eliminate these disadvantages and to indicate a stator for an electric motor, which stator is distinguished by a smaller winding overhang, a higher space factor and a higher level of automation.

### SUMMARY OF THE INVENTION

The inner ring is provided with pole shafts which project radially outwards and which can be wrapped in a direct manner. Coils which can be slipped on are thereby dispensed with. Apart from the saving on working steps for manufacturing the coils, the result is a very compact and space-saving winding, since the whole of the cavity between adjoining pole shafts is available for the said winding. The inner ring of the stator is wrapped mechanically from the outside. The use of the known drawing-in technique, which is linked with high production costs because of manual labour, and with a large winding overhang, is no more necessary than is the needle-winder technique, which results in a smaller motor output because of a lower space factor. The outer ring, which ensures the magnetic return circuit, is pushed, in a form-locking manner, onto the end-face regions of the pole shafts of the inner ring which has been wrapped. The concentric poles manufactured in this way have very small winding overhangs and permit a very short structural shape for the motor, with high efficiency. As a result of the bipartite annular structure and of the direct wrapping of the pole shafts from the outside, the manufacturing costs are considerably lower than in the case of, in particular, the drawing-in technique which is customary with a.c. stators.

According to claim 2, pole shafts of T-shaped construction are provided as holders for the windings, openings being left for wrapping purposes. In this way, a delimitation for the winding space is obtained which is fixed, apart from the openings. The windings can fill up the winding space completely, thereby avoiding problems as regards stability of shape.

In order to enclose the winding space in the optimum manner, even in the region of the openings, the outer ring is, according to claim 3, equipped on its inner side with suitable contoured sections. After the winding operation, the outer ring, which functions as a return-circuit ring, is pushed over the inner ring which functions as the stator core. The bipartite structural shape of the stator with an inner ring and an outer ring, coupled with the direct wrapping of the pole shafts, results in a minimising of the short-circuit flux. The outer ring may have an outer periphery which is circular in cross-section. An additional motor housing may be superfluous, depending upon the use to which the motor is put. The circular outer periphery also facilitates the installation of the motor in motor-driven devices, for example for a shutter drive.

### BRIEF DESCRIPTION OF THE DRAWINGS

The invention will be described in greater detail below, with the aid of an exemplified embodiment which is represented by means of drawings, in which:

FIG. 1 shows an inner ring,

FIG. 2 shows an outer ring, and

FIG. 3 shows a stator with an inner ring and an outer ring.

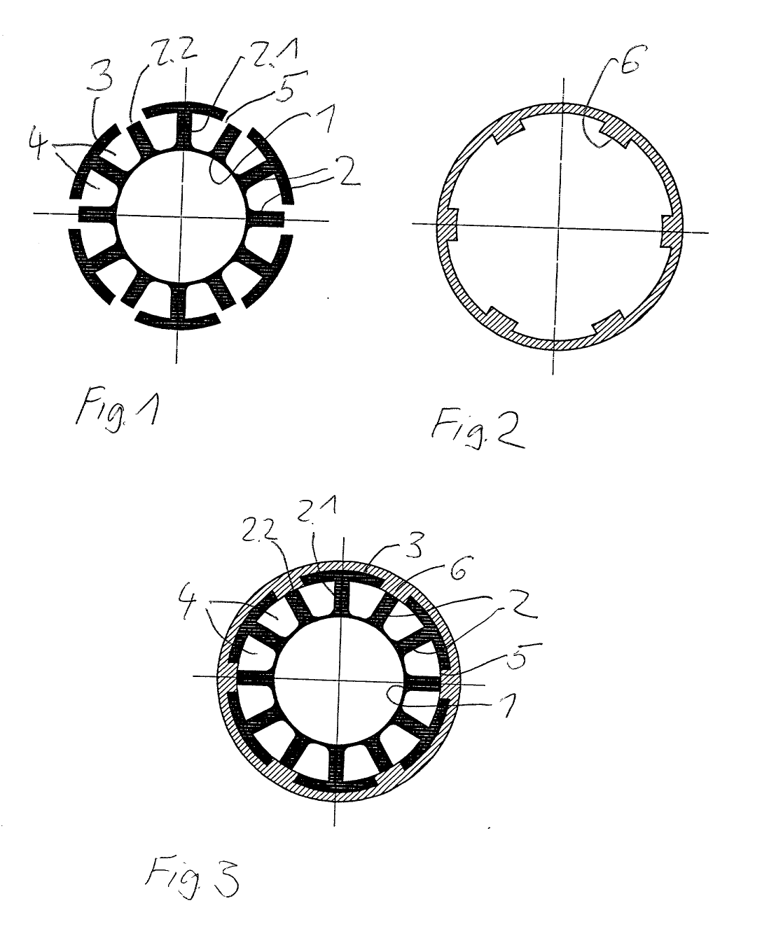

The inner ring represented in FIG. 1 essentially consists of pole pieces 1, which face towards a rotor (not represented) and are connected to one another at the periphery, and of pole shafts 2 which project outwards from the said pole pieces. Twelve pole shafts 2, which are associated, for example, with four poles on the rotor, are represented. The pole shafts 2 are constructed, in an alternating manner, as first pole shafts 2.1 which are to be wrapped, and second pole shafts 2.2 which are not. The first pole shafts 2.1 are provided with a T-shaped transverse web 3 for delimiting a winding space 4 on the outside, an opening 5 for the wrapping operation being left, in each case, between the T-shaped transverse web 3 and the adjoining second pole shaft 2.2.

The outer ring represented in FIG. 2 is provided, on its inner side, with contoured sections 6 which correspond exactly with the outer periphery of the inner ring. The outer ring can be pushed axially onto the inner ring in an accurately fitting manner, which results in the stator construction represented in FIG. 3.

The invention is not limited to the exemplified embodiment indicated above. On the contrary, a number of variants can be imagined which make use of the features of the invention, even in an embodiment of a fundamentally different type.

1. Stator for an electric motor, comprising
an inner ring having pole shafts which project radially outwards and which form first pole shafts for holding windings and second pole shafts which are disposed between the said first pole shafts, and
an outer ring which can be connected, in a form-locking manner, to end-face regions of the pole shafts.

2. Stator according to claim 1,
wherein the first pole shafts are of T-shaped construction in a manner engaging round the windings, openings being left between the first pole shafts and second pole shafts for the operation of wrapping the first pole shafts.

3. Stator according to claim 2,
wherein the outer ring has contoured sections on the inner side which engage round the pole shafts peripherally and close the openings.
